(19) United States
(12) Patent Application Publication
(10) Pub. No.: US 2026/0159088 A1
(43) Pub. Date: Jun. 11, 2026

(54) Method and Device for the Operation of a Driving Function When Approaching a Signaling Unit

(71) Applicant: Bayerische Motoren Werke Aktiengesellschaft, Muenchen (DE)

(72) Inventors: Helena DOLINAJ, Muenchen (DE); Tamas FENDLER, Eching (DE); Martin JAENSCH, Muenchen (DE); Robert KNORRN, Frankfurt am Main (DE)

(21) Appl. No.: 19/124,352

(22) PCT Filed: Oct. 24, 2023
(86) PCT No.: PCT/EP2023/079665

§ 371 Date: Apr. 25, 2025

(30) Foreign Application Priority Data
Oct. 27, 2022 (DE) 10 2022 128 566.9

(51) Int. Cl. B60W 30/18; B60W 50/14

(52) U.S. Cl. CPC B60W 30/18154; B60W 50/14; B60W 2520/10; B60W 2554/802; B60W 2720/106

(57) ABSTRACT

The invention relates to a device for the operation of a driving function for automated control of a vehicle when approaching a signaling unit. The device determines a first driving speed value based on distance information relating to the distance of the signaling unit from the vehicle, and based on a first deceleration value for the deceleration of the vehicle. The device compares the actual speed of the vehicle with the first driving speed value and, according to the comparison, brings about or inhibit one or more driving function measures in relation to the driving function. The one or more driving function measures comprise: issuing a suggestion for manual application of the signaling unit to the operation of the driving function; automatic application of the signaling unit to the operation of the driving function; and/or reducing an acceleration value of an acceleration of the vehicle.

### BACKGROUND AND SUMMARY

The invention relates to a device and a corresponding method for operating a driving function of a vehicle, in particular a speed control operation of the vehicle, if approaching a signaling unit.

A vehicle can have one or more driving functions, in particular to support the longitudinal and/or lateral control of the vehicle. An example of a driving function for supporting the longitudinal control of a vehicle is the Adaptive Cruise Control (ACC) function, which can be used to control the vehicle longitudinally at a defined set or target speed and/or at a defined set or target distance from a vehicle in front of the vehicle. The driving function can also be used in conjunction with a signaling unit (in particular a traffic light) at a intersection (such as an intersection) to bring about automated longitudinal control, such as automated deceleration, at the signaling unit.

The present document deals with the technical task of increasing the comfort of a driving function for automated longitudinal control of a vehicle at a signaling unit.

The task is solved by each of the independent claims. Advantageous embodiments are described, inter alia, in the dependent claims. It should be noted that additional features of a claim dependent on an independent claim without the features of the independent claim or only in combination with a subset of the features of the independent claim can form a separate and independent.

Combination of all features of the independent claim, which can be made the subject of an independent claim, a divisional application, or a subsequent application. This applies in the same way to technical teachings described in the description, which can form an invention that is independent of the features of the independent claims.

According to one aspect, a device for operating a driving function for the automated longitudinal control of a (motor) vehicle is described if approaching a signaling unit located ahead (e.g., a traffic light or a traffic sign).

The signaling unit can comprise a traffic light, in particular. The device can be set up to take into account the signaling unit, in particular the signaling status (e.g., the color) of the signaling unit, during the automated longitudinal control of the vehicle. Depending on the signaling status of the signaling unit, the device can, for example, be set up to ensure that the vehicle is automatically controlled longitudinally past the signaling unit using a speed control operation at a target driving speed (if the signaling status (e.g. green) indicates that the vehicle has clear lane at the intersection). On the other hand, the device can be set up to automatically decelerate the vehicle to a stop at the stop position of the signaling unit (if the signaling status (e.g. green or red) indicates that the vehicle must stop at the signaling unit).

The device can be set up to determine distance information in relation to the (temporal and/or spatial) distance of the signaling unit in front of the vehicle. In particular, the distance can be determined in seconds of travel time and/or in meters of travel distance.

The distance information can be determined based on sensor data from one or more environment sensors (e.g. a camera and/or a lidar sensor) of the vehicle and/or based on a digital map for the road network travelled by the vehicle. This data can also be used to detect the signaling unit ahead.

The device can also be set up to determine a first driving speed value based on the distance information in relation to the distance of the signaling unit ahead from the vehicle and based on a (predefined) first deceleration value for decelerating the vehicle.

The device can be set up to determine the first driving speed value in such a way that the vehicle comes to a stop at the stop position of the signaling unit, which is at the distance from the vehicle indicated by the distance information, if applying a constant deceleration with the first deceleration value, starting from a driving speed with the first driving speed value (exactly).

Alternatively or additionally, the device can be set up to determine the first driving speed, based on, in particular if,

$$v = \sqrt[2]{2 \vert a \vert d}$$

where [a] is the amount of the first deceleration value, and where d is the distance to the stop position of the signaling unit indicated by the distance information.

The device can also be set up to compare the actual speed of the vehicle with the first driving speed value. In particular, it can be determined whether the actual speed is greater or less than the first driving speed value.

The device can also be set up to compare the actual speed of the vehicle with the first driving speed value. In particular, it can be determined whether the actual speed is greater or less than the first driving speed value.

Furthermore, the device can be set up to bring about or inhibit one or more driving function measures in relation to the driving function, depending on the comparison. One or more driving function measures can be brought about if the actual speed of the vehicle is equal to or greater than the first driving speed. On the other hand, one or more driving functions measures can be inhibited if the actual speed of the vehicle is less than the first driving speed.

One or more driving function measures can include:
issuing a suggestion for a manual application of the signaling unit in the operation of the driving function (if the driving function is operated in a manual mode);
the automatic application of the signaling unit in the operation of the driving function (if the driving function is operated in an automatic mode); and/or
a reduction of the acceleration value of the acceleration of the vehicle used in the speed control operation of the driving function, relative to a standard value.

It is thus possible to adapt the operation of the driving function with respect to a signaling unit ahead as a function of the actual speed of the vehicle relative to a first driving speed value (dependent on a comfortable first deceleration value). This enables a particularly comfortable operation of the driving function.

The device can be set up to determine a current first driving speed value during the approach of the vehicle to the signaling unit in front of it, for each point in time of a sequence of points in time (repeatedly, in particular periodically), in each case based on distance information in relation to the respective current distance and based on the first deceleration value. The respective current actual speed of the vehicle can then be compared with the respective current first driving speed, and one or more friction measures can be activated or deactivated depending on the respective comparison. In this way, a permanently comfortable operation of the driving function can be achieved (during the entire approach process to the signaling unit).

The device can be set up to determine whether the distance is greater than or less that a (predefined) distance threshold value based on the distance information in relation to the distance of the signaling unit in front of it. One or more driving functions measures can be brought about independently of the comparison of the actual speed with the first driving speed value (in any case) if the distance is less than the distance threshold. On the other hand, one or more driving functions measures can be selectively activated or deactivated according to the comparison of the actual speed with the first driving speed if the distance is greater than the distance threshold value.

The speed comparison-dependent operation of the driving function can thus be limited to relatively large distances from the signaling unit, which further increases the comfort of the driving function.

The device can be set up to determine a second driving speed based on the distance information in relation to the distance of the signaling unit ahead from the vehicle and based on a second deceleration value for the deceleration of the vehicle, wherein the amount of the second deceleration value is smaller than the first deceleration value. The second driving speed can be determined in the same way as the first driving speed, but using the second deceleration value instead of the first deceleration value.

The actual speed of the vehicle can then be compared with the second driving speed, and the one or more driving functions measures can be activated or deactivated according to the comparison of the actual speed with the first driving speed and depending on the comparison of the actual speed with the second driving speed. By considering two different driving speeds, the comfort and stability of the driving function can be further increased.

The device can in particular be set up to bring about one or more driving function measures if the actual speed of the vehicle is equal to or greater than the first driving speed value.

On the other hand, one or more driving function measures can be inhibited if the actual speed of the vehicle is less than the second driving speed value. A hysteresis range can be provided between the two driving speed values to further increase the comfort and stability of the driving function.

The device can in particular be set up to determine a status Zn of the driving function during the approach of the vehicle to the signaling unit ahead for each point in time n of the sequence of points in time. Here, if the actual speed is equal to or greater than the first driving speed value, the status can correspond to a first status value, in which the one or more driving function measures are brought about. Furthermore, if the actual speed is equal to or less than the second driving speed value, the status Zn can correspond to a second status value, in which one or more driving function measures are inhibited. Furthermore, if the actual speed is less than the first driving speed and greater than the second driving speed value, the status Zn at time n can correspond to the status Zn 1 at a (directly) preceding point in time n−1. The comfort and stability of the driving function can be further increased by using a status that is iteratively adapted over time.

The device can be set up to maintain an automatic application of the signaling unit in the operation of the driving function at time n, if the automatic application has already taken place at a previous point in time, even if the actual speed at time n is equal to or less than the second driving speed value. In the automatic mode of the driving function, it is therefore possible to inhibit an automatic application of the signaling unit that has already taken place from being reversed, which further increases the comfort of the driving function.

According to a further aspect, a motor (road) vehicle (in particular passenger car or truck or bus or motorcycle) which comprises the device described in this document.

According to a further aspect, a method for operating a driving function for automated longitudinal control of a (motor) vehicle if approaching an signaling unit ahead (e.g. at a traffic signal or at a traffic sign) is described. The method comprises the determination, based on distance information in relation to the distance of the signaling unit ahead from the vehicle and based on a (predefined) first (desired) deceleration value for the deceleration of the vehicle, of a first driving speed value.

The method further comprises the comparison of the actual speed of the vehicle with the first driving speed value, and the bringing about or inhibiting of one or more driving function actions in relation to the driving function, depending on the comparison.

According to a further aspect, a software (SW) program is described. The SW program can be set up to be executed on a processor (e.g. on a control unit of a vehicle), and thereby to execute the method described in this document.

According to a further aspect, a storage medium is described. The storage medium can comprise a SW program set up to be executed on a processor, and thereby to execute the method described in this document.

In the context of the document, the term “automated driving” can be understood to mean driving with automated longitudinal or lateral control or autonomous driving with automated longitudinal and lateral control. Automated driving can be, for example, a longer period of driving on the highway or a limited period of driving in the context of parking or maneuvering. The term “automated driving” includes automated driving with any degree of automation. Example of a degrees of automation are assisted, partially automated, highly automated, or fully automated driving. These degrees of automation have been defined by the Federal Highway Research Institute (BASt) (see BASt publication “Forschung kompakt”, issue November 2012).

In assisted driving, the driver permanently performs longitudinal or lateral control, while the system takes over the other function within certain limits. In semi-automated driving (ADAS), the system takes over longitudinal and lateral control for a certain period of time and/or in specific situations, wherein the driver must continuously monitor the system as in assisted driving. In highly automated driving (HAD), the system takes over longitudinal and lateral control for a certain period of time without the driver having to permanently monitor the system; however, the driver must be able to take over vehicle control within a certain period of time. With fully automated driving (FAD), the system can automatically manage driving in all situations for a specific use case; a driver is no longer required for this use case.

The four levels of automation mentioned above correspond to SAE levels 1 to 4 of the SAE J3016 standard (SAE—Society of Automotive Engineering). For example, highly automated driving (HAD) corresponds to level 3 of the SAE J3016 standard.

SAE J3016 also provides for SAE Level 5 as the highest degree of automation, which is not included in the BASt definition. SAE level 5 corresponds to a driverless driving in which the system can automatically handle all situations during the entire journey like a human driver; a driver is generally no longer required. The aspects described in this document relate in particular to a driving function or a driver assistance function that are designed in accordance with SAE Level 2.

It should be noted that the methods, devices, and systems described in this document can be used alone or in combination with other methods, devices and systems described in this document. Furthermore, any aspects of the methods, devices and systems described in this document can be combined with each other in a variety of ways. In particular, the features of the claims can be combined with each other in a variety of ways. Furthermore, features listed in brackets are to be understood as optional features.

The invention is described in more detail below using examples of embodiments.

### BRIEF DESCRIPTION OF THE DRAWINGS

FIG. 1 illustrates an example of a components of a vehicle;

FIG. 2a illustrates an example of a traffic signal system;

FIG. 2b illustrates an example of a traffic sign;

FIG. 3a illustrates an example of a driving situation;

FIG. 3b illustrates an example of a velocity curves of the vehicle in the driving situation shown in FIG. 3a;

FIG. 4 illustrates an example of a progressions of driving speed values for an approach process to a signaling unit; and

FIG. 5 is a flow chart of an example of a method for the operation of a driving function of a vehicle at a signaling unit.

### DETAILED DESCRIPTION OF THE DRAWINGS

As stated at the beginning, the present document relates to the increase of the comfort of a driving function, in particular a driver assistance system, of a vehicle, in conjunction with a signaling unit at an intersection of the roadway driven by the vehicle. In particular, the present document deals with how to enable a comfortable and safe speed control operation at a signaling unit and/or a comfortable application of a signaling unit for operating a driving function.

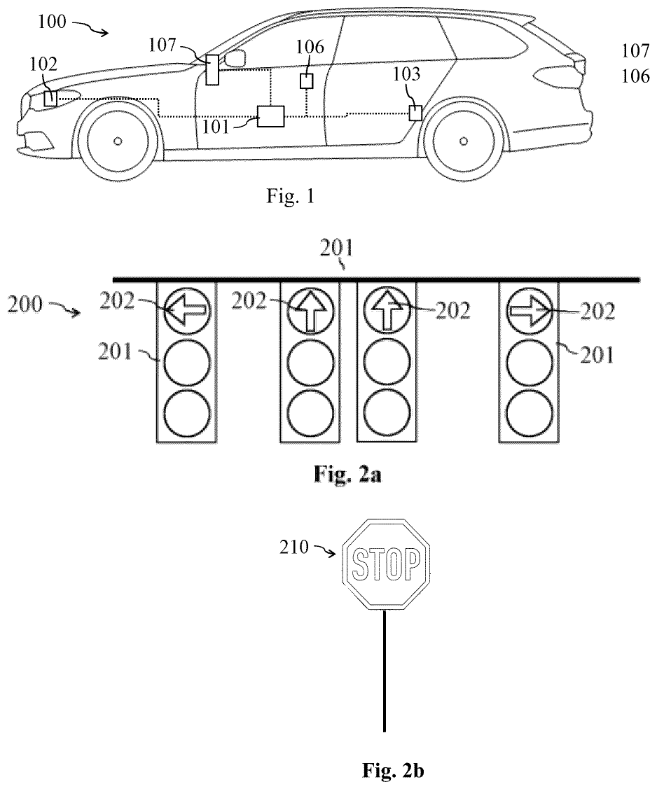

FIG. 1 shows example of a components of a vehicle 100. The vehicle 100 comprises one or more environmental sensors 102 (e.g. one or more image cameras, one or more radar sensors, one or more lidar sensors, one or more ultrasound sensors, etc.), which are each designed to record environmental data in relation to the environment of the vehicle 100 (in particular in relation to the environment in the direction of travel in front of the vehicle 100). In addition, the vehicle 100 comprises one or more actuators 103, which are each set up to have an impact on the longitudinal and/or latitudinal control of the vehicle 100. Example of a actuators 102 are: a brake system, a drive motor, a steering system, etc.

The (control) device 101 of the vehicle 100 can be set up to provide a driving function, in particular a driver assistance function, based on the sensor data of one or more environmental sensors 102 (i.e. based on the environmental data). For example, an obstacle on the driving trajectory of the vehicle 100 can be recognized based on the sensor data. The device 101 can then control one or more actuators 103 (e.g. the brake system) to automatically decelerate the vehicle 100 and thereby inhibit a collision of the vehicle 100 with the obstacle.

In the context of the automated longitudinal control of a vehicle 100, besides a vehicle in front, one or more signaling units (e.g. a traffic light system and/or a traffic signs) can be taken into account on the roadway or road driven on by the vehicle 100. In particular, the signaling status of a light signal or traffic light system can be taken into account so that the vehicle 100 automatically decelerates to the stop position of the traffic light at a red traffic light relevant to its own (planned) direction of travel and/or accelerates (possibly again) at a green traffic light.

FIG. 2a shows an example of a traffic light system 200. The traffic light system 200 shown in FIG. 2a comprises four different signal generators 201, which are arranged at different positions on an approach to a traffic junction (e.g. at an intersection). The left signal generator 201 comprises an arrow 202 pointing to the left, indicating that this signal generator 201 is for left turners. Both middle signal generators 201 comprise an up arrow pointing upwards 202 (or no arrow 202) indicating that these two signal generators 201 are for straight-ahead driving. The individual light signs of these two signal generators 201 form signal groups. In addition, the right signal generator 201 comprises an arrow 202 pointing to the right, indicating that this signal generator 201 applies for right turners.

FIG. 2b shows an example of a stop sign as a traffic sign 210, regulating the right of way at a traffic junction, in particular at an intersection. The (control) device 101 of the vehicle 100 can be designed to recognize a traffic sign 210 relevant to the journey of the vehicle 100 on the road or roadway driven on by the vehicle 100, based on the sensor data of one or more environmental sensor 102 (i.e. based on the environmental data) and/or based on a digital map (i.e. based on map data).

As part of an (ACC) driving function, the vehicle 100 can be automatically controlled longitudinally according to a set or target speed and/or according to a set or target distance to a vehicle in front driving (directly) in front of the vehicle 100. For this purpose, the driving function can have a speed control that sets, in particular regulates, the actual driving speed of the vehicle 100, according to the set or target speed. Alternatively or additionally, the driving function can have a distance controller that sets, in particular regulates, the actual distance of the vehicle 100 from the vehicle in front, according to the set or target distance. If no relevant vehicle in front exists or if the vehicle in front is driving more quickly than the set or target speed, the driving speed of the vehicle 100 can be set, in particular regulated, according to the set or target speed. Alternatively or additionally, if the vehicle in front is driving more slowly than the set or target speed, the distance of the vehicle 100 from the vehicle in front can be set, in particular regulated, according to the set or target distance.

The device 101 of the vehicle 100 can be arranged to provide an automated longitudinal control of the vehicle 100 in the urban area. This driving function can be referred to as Urban Cruise Control (UCC) driving function. The driving function can be provided in an automatic mode (aUCC) and/or in a manual mode (mUCC). If necessary, the driver can be enabled to specify via the user interface 107 of the vehicle 100 whether the driving function is to be operated in automatic or in manual mode

The device 101 of the vehicle 100 can be set up to detect a signaling unit ahead 200 on the driving route of the vehicle 100 based on the environmental data of one or more environmental sensors 102 and/or based on map data in relation to the roadway network driven on by the vehicle 100 (in conjunction with the position data of a position sensor 106 of the vehicle 100). In manual mode of the UCC driving function a suggestion or a request (i.e. the issue of a request) can be made via the user interface 107 as to whether or not the signaling unit 200, 210 should be taken into account in the automated longitudinal control of the vehicle 100 (i.e. whether the signaling unit 200, 210 should be included in the operation of the driving function).

The driver of the vehicle 100 can then accept or reject or ignore the suggestion, e.g. by activating a control device of the user interface 107. On the other hand, in automatic mode of the UCC driving function, the detected signaling unit 200, 210 can be taken into account automatically (i.e. without the need for feedback from the driver) in the automated longitudinal control of the vehicle 100, if necessary, (i.e. included in the operation of the driving function).

A request for application of the signaling unit 200, 210 for the operation of the (UCC) driving function can thus be made in manual mode. An automatic application of the signaling unit 200, 210 can be made for the operation of the (UCC) driving function in automatic mode.

If the detected signaling unit 200, 210 is taken into account (i.e. applied) in the automated longitudinal control of the vehicle 100, an automatic deceleration can be triggered to automatically bring the vehicle 100 to a stop (e.g. at a red traffic light or at a stop sign) (depending on the type and/or (signaling) status of the signaling unit 200, 210). Furthermore, an automatic start of the vehicle 100 can be triggered (e.g. after change of the (signaling) status of the signaling unit 200, 210, for example after a change to green). The vehicle 100 can then be automatically accelerated back to the target speed (taking into account a specified minimum or target distance to a vehicle in front).

The UCC driving function thus enables the driver of a vehicle 100 to use the ACC driving function on the road with one or more signaling units 200, 210 (without having to deactivate and reactivate the ACC function each time at the individual signaling units 200, 210).

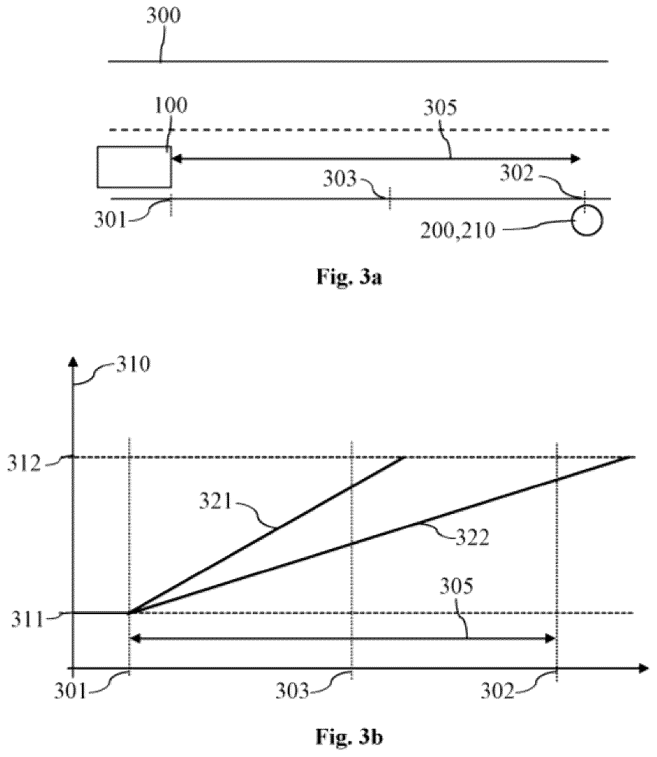

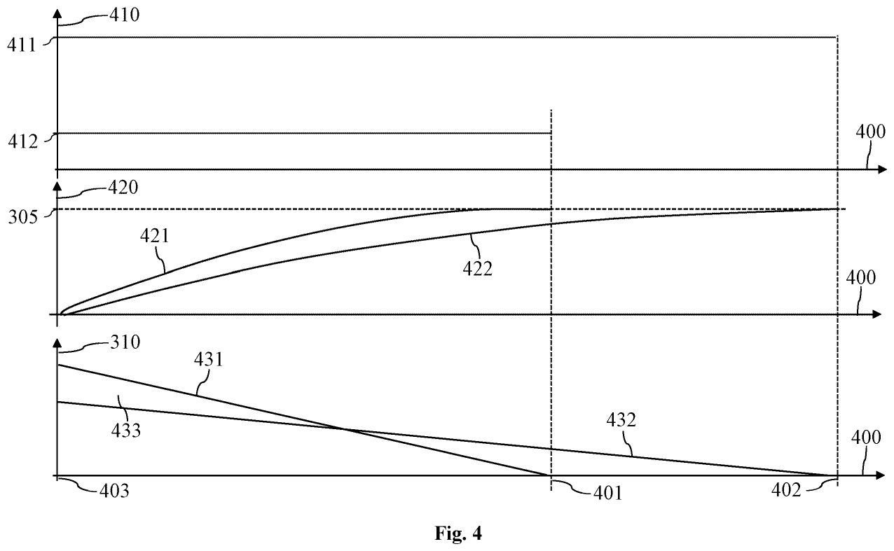

It may happen that the vehicle 100, such as shown for example in FIGS. 3a and 3b, approaches a signaling unit 200, 210 at an actual speed 311 that is less than the target speed 312 of the driving function, even though the vehicle 100 is in a clear lane. This may happen for example if the user of the vehicle 100 activates the driving function while the vehicle 100 is driving towards the signaling unit 200, 210 on a roadway 300. Alternatively, such a situation can occur if the vehicle 100 was initially following behind a (relatively slow driving) vehicle in front, and the vehicle in front has left the roadway 300 (e.g. has turned off onto a driveway).

It can thus be detected by the control device 101 of the vehicle 100 that the vehicle 100 finds itself using the active driving function in a clear lane (without a vehicle in front) and has an actual speed 311 that is (significantly) less than the target speed 312 of the speed control of the driving function. The vehicle 100 could accelerate at a (relatively high) standard acceleration (i.e. at a relatively high standard value of the acceleration) of the speed control to set, in particular to regulate, the driving speed 310 of the vehicle 100 to the target speed 312. However, this could lead to a situation in which the vehicle 100 accelerates with the relatively high standard acceleration, although the vehicle 100 should come to a stop at the stop position 302 of a signaling unit ahead 200, 210. This can lead to an uncomfortable situation for the user of the driving function. In particular, the use of a relatively high standard acceleration can reduce the time available for the user of the vehicle 100 to select (i.e. apply) the signaling unit 200, 210 in manual mode of the driving function.

The (control) device 101 can be designed to determine the distance information in relation to the distance 305 between the starting position 301 of the vehicle 100 (e.g. if activating the speed control operation) and the stop position 302 of the signaling unit 200, 210. The starting position 301 can correspond to the position of the vehicle 100 at which it is detected that a clear lane situation of the vehicle 100 occurs, and the vehicle 100 should therefore accelerate to the target speed 312.

The value of the acceleration can be determined as a function of the distance information. The value of the acceleration can be increased with increasing distance 305. For example, the standard value of the acceleration can be used if the distance 305 is greater than a certain distance value. On the other hand, a reduced value of the acceleration compared to the standard value can be used if the distance 305 is equal to or less than the distance value.

FIG. 3b shows the velocity curve 321 of the speed 310 of the vehicle 100 when using the standard value of the acceleration. In addition, FIG. 3b shows the velocity curve 322 when using the reduced value of the acceleration. The reduced value of the acceleration extends the time until the vehicle 100 reaches the decision position 303 at which the driver must decide at the latest whether or not to take into account the signaling unit ahead 200, 210 when operating the driving function. The comfort for the driver of the vehicle 100 is thus increased.

As stated further above, a suggestion for the application of a detected signaling unit 200, 210 was to be issued in manual mode of the driving function. On the other hand, a detected signaling unit 200, 210 can be automatically applied in the automatic mode of the driving function. If the suggestion is issued too early or unnecessarily or a relatively late and/or automatic application occurs, this can lead to a loss of comfort.

In this document, measures are described to increase the comfort of the driving function in relation to the issuing of a suggestion and/or the automatic application of a signaling unit 200, 210.

In this context, FIG. 4 shows different decelerations 410 that may change over time 400 during an approach to a signaling unit 200, 210 or that are constant over time.

In particular, a first deceleration value 411 can be defined. The first deceleration value 411 can, for example, correspond to a desired deceleration (possibly defined by the user of the vehicle 100) for an automated deceleration process at a signaling unit 200, 210.

FIG. 4 also shows a first course of the road 421 covered by the vehicle 100 until the stop position 302 of the signaling unit 200, 210 using a (constant) deceleration 410 with the first deceleration value 411. The vehicle 100 reaches the stop position 402 at a starting point in time 401. FIG. 4 also shows a first velocity curve 431 of the driving speed 310 of the vehicle 100 between the initial point in time 403 (from which the deceleration 420 is brought about with the first deceleration value 411) until the starting point in time 401 (at which the vehicle 100 comes to a stop at the stop position 302).

The first velocity curve 431 indicates a first driving speed for a sequence of points in time 400. The first driving speed 431 decreases as the distance between the vehicle 100 and the stop position 302 of the signaling unit 200, 210 decreases.

The device 101 of the vehicle 100 can be set up to compare the actual speed of the vehicle 100 at a point in time 400, in particular at the starting point 403, with the first driving speed for this point in time 400. The issuing of a suggestion and/or the automatic application in relation to the signaling unit ahead 200, 210 can then be brought about or inhibited, according to the comparison. In particular, the issuing of a suggestion and/or the automatic application can (possibly only then) be brought about if the actual speed is equal to or greater than the first driving speed. On the other hand, the issuing of a suggestion and/or the automatic application possibly be inhibited if the actual speed is less than the first driving speed value.

During the approach process of the vehicle 100 at the signaling unit 200, 210 the issuing of a suggestion and/or the automatic application can possibly only or precisely take place at the point in time 400 when the actual speed of the vehicle 100 reaches or exceeds the first driving speed (for the first time).

This means that the issuing of a suggestion and/or the automatic application can take place at a point in time 400 during an approach process that leads to a comfortable deceleration of the vehicle 100. Unnecessary issuing of a suggestion can also be reliably avoided.

The device 101 can be set up to bring about or inhibit the reduction of the driving function described in the context of FIGS. 3a and 3b, in particular acceleration brought about by the speed control, according to the comparison between the actual speed of the vehicle 100 and the first driving speed value. The reduction of the acceleration can be brought about (possibly only then) if the actual speed of the vehicle 100 is equal to or greater than the first driving speed value. On the other hand, the reduction of the acceleration can be inhibited if the actual speed of the vehicle 100 is less than der first driving speed value.

Such a selective reduction of the (maximum possible) acceleration used by the driving function, in particular by the speed control can further increase the comfort of the driving function.

FIG. 4 shows a second deceleration value 412, which in terms of amount is less than the first deceleration value 411, and consequently leads to a slower deceleration 410 of the vehicle 100 than the first deceleration value 411. Using the second deceleration value 412 results in the second course of the road 422 shown in FIG. 4, which runs up to a second point in time 402 (which follows the first point in time 401) to achieve the stop position 302 of the signaling unit 200, 210. FIG. 4 also shows a second velocity curve 432, which displays second speed values for a sequence of points in time 400, in the event that the vehicle 100 is decelerated (consistently) with the second deceleration value 412.

The actual speed of the vehicle 100 (e.g. at the point in time 403) can be compared with the second speed value (for the point in time 403). The issuing of a suggestion, the automatic application and/or reduction of the acceleration can (possibly only then) be inhibited if the actual speed value is less than the second speed value.

As can be seen from FIG. 4, a hysteresis range 433, which can be used to inhibit a jumping back-and-forth between different statuses of the driving function results between the second velocity curve 432 and the first velocity curve 431. If the actual speed of the vehicle 100 lies between the second speed value and the first speed value (and thus within the hysteresis range (433), the current status of the driving function can be maintained in relation to the issuing of a suggestion and in relation to the reduction of the acceleration used by the speed control (and possibly in relation to the automatic application).

The device 101 can therefore be set up at a point in time n 403 to update the status Zn of the driving function in relation to the issuing of a suggestion and in relation to the reduction of the acceleration used by the speed control (and possibly in relation to the automatic application) depending on the actual speed of the vehicle 100 at the point in time n 403 and depending on the first and the second speed value at the point in time n 403. The status Zn can have a first status value at which the issuing of a suggestion, the reduction of the acceleration used by the speed control and/or the automatic application take place. On the other hand, the status Zn can have a second status value, at which the issuing of a suggestion, the reduction of the acceleration used by the speed control and/or the automatic application do not take place.

The device 101 can be set up to bring about one or more of the following status transitions from the status zₙ₋₁ at the preceding point in time n−I to the status zₙ at the current point in time n,
zₙ=first status value (independently of zₙ₋₁), if the actual speed is equal to or greater than the first speed value at the current point in time n;
zₙ=zₙ₋₁ if the actual speed is less than the first speed value and greater than the second speed value at dem current point in time n; and/or
zₙ=second status value (independently of zₙ₋₁) if the actual speed us is equal to or less than the second speed value at the current point in time n.

The above-mentioned status changes can take place, in particular in relation to the issuing of a suggestion and/or in relation to the reduction of the acceleration used by the speed control. On the other hand, for the automated application, possibly the status zₙ=first status value can be maintained (independently of the further development of the actual speed of the vehicle 100), as soon as this status was achieved for the first time. In other words, as soon as an automatic application has taken place, this preferably remains in place (independently of the further development of the actual speed of the vehicle (100). A particularly comfortable operation of the driving function can thus be brought about.

As already explained above, an unnecessary issuing of a suggestion for manual application and/or unnecessary automated application of a signaling unit 200, 210 can occur even through there is no need for deceleration (e.g. if the vehicle 100 is stationary and/or if the signaling unit 200, 210 is relatively far away). The measure described in this document can avoid such situations, thereby increasing the comfort of the driving function.

Alternatively or additionally, a reduction in the dynamics of the cruise control, which is perceived as too sluggish by a user, can be achieved. The measure described in this document can avoid such situations, thereby increasing the comfort of the driving function.

As described, the actual speed of the vehicle 100 can be compared with one or more driving speeds to detect a situation. One or more speed values can be determined based on one or more deceleration values 411, 412.

If the actual speed is less than the second speed value (which depends, for example, on a certain minimum deceleration 412), the issuing of a suggestion can be suppressed. Alternatively or additionally, the maximum acceleration limit and/or the dynamics (of the speed control) can be set to the default value in order to accelerate to the set speed.

If the actual speed is greater than the first speed value (which depends, for example, on a desired deceleration 411), the issuing of a suggestion can be activated. Alternatively or additionally, the maximum acceleration limit and/or the dynamics of the speed control can be reduced.

If it is detected that the distance 305 to the signaling unit 200, 210 falls below an (adjustable) minimum distance, the issuing of a suggestion can be brought about (without taking into account the actual speed of the vehicle 100), possibly also if there is no need for deceleration. Furthermore, the dynamics in this case can be designed (and reduced) for a deceleration situation.

One or more comparison speeds (i.e. the driving speed values) can be based on (adjustable) acceleration assumptions, with which the stop position 302 is reached exactly, assuming a constant maintenance of the deceleration. One or more driving speeds can be determined, when

$$v = \sqrt[2]{2 \vert a \vert d}$$

where |a| is the amount of the respective deceleration value 411, 412, and where d is the distance 305 to the stop position 302 of the signaling unit 200, 210.

The area arranged between the two speed values 433 serves as hysteresis in order to avoid a possible toggling back and forth of the detected situations (i.e. statuses).

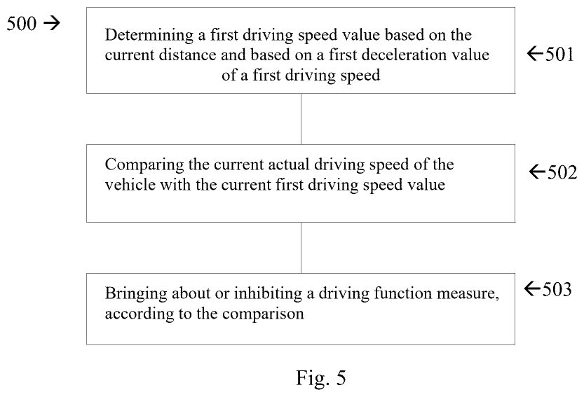

FIG. 5 shows a flowchart of an example of a (possibly computer-implemented) method 500 for operating a driving function for automated longitudinal control of a (power) vehicle 100 when approaching an signaling unit ahead 200, 210. The driving function can possibly also bring about at automated lateral control of the vehicle 100.

The method 500 comprises the determination 501 of the upcoming signal unit 200, 210 from the vehicle 100, based on distance information in relation to the distance 305 and a first driving speed value, based on a (predefined) first deceleration value 411 for the deceleration of the vehicle 100.

The method 500 further comprises the comparison 502 of the actual speed of the vehicle 100 with the first driving speed value, and the bringing about or inhibiting 503 of one or more driving function actions in relation to the driving function, according to the comparison. One or more of the driving function measures can comprise
The issuing of a suggestion for a manual application of the signaling unit 200, 210 in the operation of the driving function (if the driving function is operated in manual mode);
The automatic application of the signaling unit 200, 210 in the operation of the driving function (if the driving function is operated in automatic mode); and/or
A reduction of the acceleration value of the acceleration of the vehicle 100 using the speed control operation of the driving function, relative to a standard value.

The measures described in this document can safely increase the comfort of a driving function for automated longitudinal control at a signaling unit 200, 210.

The present invention is not limited to the embodiments shown. In particular, it should be noted that the description and the figures are only intended to illustrate the principle of the proposed method, devices and systems by way of example.

1-11. (canceled)

12. A device for operating a driving function for automated longitudinal control of a vehicle when approaching a signaling unit ahead, wherein the device is configured to:
determine a first driving speed value based on distance information in relation to a distance of the signaling unit ahead of the vehicle and based on a first deceleration value for the deceleration of the vehicle;
compare an actual speed of the vehicle with the first driving speed; and
cause or inhibit one or more driving function measures in relation to the driving function according to the comparison;
wherein the one or more driving functions measures comprise at least one of:
issue a suggestion for manual application of the signaling unit to the operation of the driving function;
automatic application of the signaling unit to the operation of the driving function; or
reduce an acceleration value of an acceleration of the vehicle, which is used within a scope of a speed control operation of the driving function, relative to a standard value.

13. The device according to claim 12, wherein the device is configured to:
cause one or more driving function measures when the actual speed of the vehicle is equal to or greater than the first driving speed; and/or
inhibits one or more driving functions measures when the actual speed of the vehicle is less than the first driving speed.

14. The device according to claim 12, wherein the device is configured to:
for each point in time of a sequence of points in time, during the approach of the vehicle to the signaling unit ahead, in each case based on distance information in relation to the respective distance and based on the first deceleration value a current first driving speed, determine a sequence of points in time;
in each case:
determine a current first driving speed value based on the distance information in relation to the respective distance and based on the first deceleration value;
compare the respective actual speed of the vehicle with the current first driving speed value; and
cause or inhibit one or more driving function measures according to the respective comparison.

15. A device according to claim 12, wherein the device is configured to:
determine the first driving speed such that the vehicle comes to a stop at the signaling unit when a constant deceleration is applied with the first deceleration value starting from a driving speed with the first driving speed at a stop position, which is removed from the vehicle at the distance indicated by the distance information.

16. A device according to claim 12, wherein the device is configured to designate the first driving speed, based on when
$$v = \sqrt[2]{2 \vert a \vert d}$$
wherein [a] is the amount of the first deceleration value, and wherein d is the distance from a stop position of the signaling unit indicated by the distance information.

17. A device according to claim 12, wherein the device is configured to:
determine a second driving speed based on the distance information in relation to the distance of the signaling unit ahead from the vehicle and based on a second deceleration value for the deceleration of the vehicle, wherein the amount of the second deceleration value is less than the first deceleration value;
compares the actual speed of the vehicle with the second driving speed; and
cause or inhibit one or more driving functions measures, according to the comparison of the actual speed with the first driving speed and, according to the comparison of the actual speed with the second driving speed.

18. A device according to claim 17, wherein the device is configured to:
cause one or more driving function measures when the actual speed of the vehicle is equal to or greater than the first driving speed; and
inhibit one or more driving function measures when the actual speed of the vehicle is less than the second driving speed.

19. A device according to claim 17, wherein:
the device is configured to determine a situation Zn of the driving function in each case during the approach of the vehicle to the signaling unit ahead for each point in time n of a sequence of points in time;
the actual speed is equal to or greater than the first driving speed, the status Zn corresponding to a first status value at which one or more driving function measures is brought about;
when the actual speed is equal to or less than the second driving speed, the status Zn corresponds to the second status value at which one or more driving function measures are inhibited; and
when the actual speed is less than the first driving speed value and greater than the second driving speed value, the status Zn at the point in time n corresponds to the status Zn−1 at a preceding point in time n−1.

20. A device according to claim 19, wherein the device is configured such that at the point in time n at automatic application of the signaling unit, the operation of the driving function is maintained when the automatic application has occurred at a preceding point in time, including when the actual speed at the point in time n is equal to or less than the second driving speed value.

21. A device according to claim 12, wherein the device is configured to:
determine whether the distance is greater than or less than a distance threshold value based on the distance information in relation to the distance of the signaling unit ahead;
cause one or more driving function measures, independently of the comparison of the actual speed with the first driving speed value, when the distance is less than the distance threshold value; and
cause or inhibits one or more driving function measures, according to the comparison of the actual speed with the first driving speed value, when the distance is greater than the distance threshold value.

22. A method for operating a driving function for automated longitudinal control of a vehicle when approaching a signaling unit ahead, the method comprising;
determining a first driving speed, based on distance information in relation to a distance of the signaling unit ahead of the vehicle and based on a first deceleration value for the deceleration of the vehicle;
comparing the actual speed of the vehicle with the first driving speed value; and
causing or inhibiting one or more driving function measures in relation to the driving function, according to the comparisons;
wherein one or more driving function measures comprise:
issuing a suggestion for a manual application of the signaling unit in the operation of the driving function;
an automatic application of the signaling unit in the operation of the driving function; and/or
a reduction of an acceleration value of an acceleration of the vehicle, which is used within the scope of a speed control operation of the driving function, relative to a standard value.
